(19) United States
(12) Patent Application Publication
(10) Pub. No.: US 2021/0350427 A1
(43) Pub. Date: Nov. 11, 2021

(54) METHOD AND DEVICE FOR COST EARLY WARNING OF PREFABRICATED BUILDING

(71) Applicant: CHINA CONSTRUCTION SCIENCE & TECHNOLOGY GROUP CO., LTD., Shenzhen, Guangdong (CN)

(72) Inventors: Zesen FAN, Shenzhen, Guangdong (CN); Zhonghua ZHANG, Shenzhen, Guangdong (CN); Hui SUN, Shenzhen, Guangdong (CN); Shilong SU, Shenzhen, Guangdong (CN); Xinwei LI, Shenzhen, Guangdong (CN); Rong TENG, Shenzhen, Guangdong (CN); Weihong JIAN, Shenzhen, Guangdong (CN)

(73) Assignee: CHINA CONSTRUCTION SCIENCE & TECHNOLOGY GROUP CO., LTD., Shenzhen, Guangdong (CN)

(21) Appl. No.: 17/277,920

(22) PCT Filed: Sep. 20, 2018
(86) PCT No.: PCT/CN2018/106717

§ 371 Date: Mar. 19, 2021

(51) Int. Cl. G06Q 30/02

(52) U.S. Cl. CPC G06Q 30/0283

(57) ABSTRACT

This application provides a method and a device for cost early warning of a prefabricated building. The method includes: acquiring price information of materials of components in different purchase periods, and performing statistics on the price information to acquire a price change trend corresponding to the material of each component; acquiring a current price, a bid price, a cost profit and loss of the material purchased for a construction project, a quantity of the material remained and a pre-made component production plan, and generating a procurement plan according to the price change trend, the current price, and the bid price, the cost profit and loss of the material purchased, the quantity of the material remained and the pre-made component production plan; calculating a real-time cost profit and loss of the construction project according to the procurement plan, the bid price, and the cost profit and loss of the material purchased.

### CROSS REFERENCE TO THE RELATED APPLICATION

This application is the U.S. National Phase entry of International Application No. PCT/CN2018/106717, filed on Sep. 20, 2018, the entire contents of which are incorporated herein by reference.

### TECHNICAL FIELD

The present application relates to the technical field of prefabricated buildings, and in particular to a method and a device for cost early warning of a prefabricated building.

### BACKGROUND

A building assembled from prefabricated parts on the site is called prefabricated building; with the development of modern industrial technology, building houses can be manufactured in batches like machine production. As long as the prefabricated building components are transported to the construction site and assembled, they can be built.

However, the prices of materials for produce components change with the market, such that it may be impossible to accurately predict a construction cost of the building.

### SUMMARY

### Technical Problem

The present application provides a method and a device for cost early warning of a prefabricated building, aiming to solve the technical problem that the construction cost of the building cannot be accurately predicted.

### Technical Solutions

A first aspect of the present application provides a method for cost early warning of a prefabricated building, including:
acquiring price information of materials of components at different purchase periods, and performing statistics on the price information to acquire a price change trend corresponding to the material of each component;
acquiring a current price of the material, a bid price of the material, a cost profit and loss of the material that has been purchased for a construction project, a quantity of the material remained, and a pre-made component production plan, and generating a procurement plan of the material according to the price change trend, the current price of the material and the bid price of the material, the cost profit and loss of the material that has been purchased for the construction project, the quantity of the material remained and the pre-made component production plan;
calculating the real-time cost profit and loss of the construction project according to the procurement plan, the bid price, and the cost profit and loss of the material that has been purchased.

A second aspect of the present application provides a device for cost early warning of a prefabricated building, including:
an acquisition unit which is configured to acquire price information of materials of components at different purchase periods, and to perform statistics on the price information to acquire a price change trend corresponding to the material of each component;
a generation unit which is configured to acquire a current price of the material, a bid price of the material, a cost profit and loss of the material that has purchased in a construction project, a quantity of the material remained and a pre-made component production plan, and to generate a procurement plan of the material according to the price change trend, the current price of the material and the bid price of the material, the cost profit and loss of the material that has been purchased for the construction project, the quantity of the material remained and the pre-made component production plan
a calculation unit which is configured to calculate a real-time cost profit and loss of the construction project according to the procurement plan, the bid price and the cost profit and loss of the material that has been purchased.

A third aspect of the present application provides a terminal device, including a memory, a processor and a computer program stored in the memory and capable of running on the processor, and when the computer program is executed by a processor, the steps of the method of the first aspect are implemented.

A fourth aspect of the present application provides a computer-readable storage medium which stores a computer program, and when the computer program is executed by a processor, the steps of the method of the first aspect are implemented.

### Beneficial Effects

In embodiments of the present application, by acquiring price information of materials of components at different purchase periods, and performing statistics on the price information, a price change trend corresponding to the material of each component is acquired, and then, according to the price change trend, a current price of the material, a bid price of the material, a cost profit and loss of the material that has been purchased for a construction project, a quantity of the material remained and a pre-made component production plan to generate a procurement plan of the material, so that the procurement plan is a comprehensive consideration of the price change trend of the material, the current price of the material, the bid price of the material, the cost profit and loss of the material that has been purchased for the construction project, the quantity of the material remained and the optimal procurement plan acquired from the pre-made component production plan, so that the procurement of the material can reasonably reduce the construction cost of the building when the material price changes with the market without affecting the construction period, meanwhile, the user can also check a real-time cost profit and loss of the construction project acquired by calculating the procurement plan, the bid price and the cost profit and loss of the purchased material, to obtain the latest cost profit and loss of the construction project, that is, the user can acquire the cost profit and loss of the construction project in different periods in real time, which solves the problem that the construction cost of the building cannot be accurately predicted because the prices of the materials for the production components change with the market.

### BRIEF DESCRIPTION OF DRAWINGS

In order to explain the technical solutions in the embodiments of the present application more clearly, a brief description of the appended drawings that need to be used in the description of the embodiments or the prior art is given below. Obviously, the drawings described below are merely some embodiments of the present application, for those of ordinary skill in the art, other drawings may be acquired based on these drawings on the premise of no creative labor.

FIG. 1 is a schematic diagram of an implementation process of a method for cost early warning of a prefabricated building provided by an embodiment of the present application;

FIG. 2 is a schematic diagram of the implementation process of step 102 of the method for cost early warning of the prefabricated building provided by an embodiment of the present application;

FIG. 3 is a schematic diagram of a trend of material price change provided by an embodiment of the present application;

FIG. 4 is a schematic diagram of the implementation process of step 103 of the method for cost early warning of the prefabricated building provided by an embodiment of the present application;

FIG. 5 is a schematic diagram of a device for cost early warning of a prefabricated building provided by an embodiment of the present application;

FIG. 6 is a schematic diagram of a terminal device provided by an embodiment of the present application.

### DETAILED DESCRIPTION

In the following description, for the purpose of illustration rather than limitation, specific details such as a specific system structure and technology are proposed for a thorough understanding of the embodiments of the present application. However, it should be clear to those skilled in the art that the present application can also be implemented in other embodiments without these specific details. In other cases, detailed descriptions of well-known systems, devices, circuits, and methods are omitted to avoid unnecessary details from obstructing the description of the present application.

It should be understood that when used in this specification and appended claims, the term “comprising” indicates the existence of the described features, integers, steps, operations, elements, and/or components, but does not exclude the existence or addition of one or more other features, integers, steps, operations, elements, components, and/or groups thereof.

It should also be understood that the terms used in the specification of the present application are only for the purpose of describing specific embodiments and are not intended to limit the application. As used in the specification and the appended claims of the present application , unless the context clearly indicates other circumstances, the singular forms “a”, “an” and “the/said” are intended to include plural forms.

It should be further understood that the term “and/or” used in the specification and appended claims of the present application refers to any combination and all possible combinations of one or more of the associated listed items, and includes these combinations.

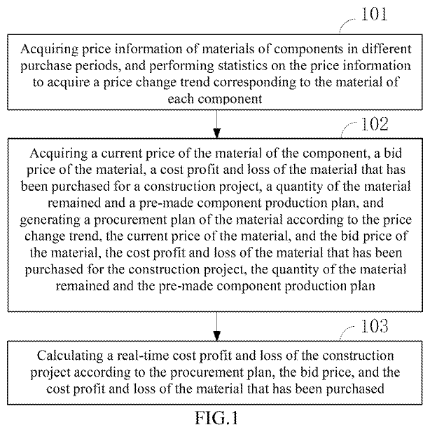

FIG. 1 shows a schematic diagram of the implementation process of a method for cost early warning of a construction project provided by an embodiment of the present application. The method may include steps 101 to 104, and is suitable for situations where it is necessary to accurately predict the construction cost of a building.

Step 101: acquiring price information of materials of components in different purchase periods, and performing statistics on the price information to acquire a price change trend corresponding to the material of each component.

Among them, the components refers to prefabricated housing components used for assembly building in the prefabricated building. When a design of the construction project is completed and the construction starts, a production of various components can be started according to a construction period. During a production of components, the first thing to do is to purchase the materials of the components. A production cost of the components can be calculated by acquiring purchase prices of the materials.

In order to avoid the situation that the cost of material is far greater than the budgeted cost due to market changes, the cost early warning cannot be realized. In an embodiment of the present application, the price information of the materials of the components at different purchase periods is acquired to calculate the price change trend corresponding to the material of each component, and then, based on the price change trend, a current price of the material, a bid price of the material, a cost profit and loss of the material that has been purchased for a construction project, a quantity of the material remained and a pre-made component production plan to generate a procurement plan of the material. Such that the above procurement plan is the optimal one that has comprehensively considered the price change trend of the material, the current price of the material, the bid price of the material, the cost profit and loss of the material that has been purchased for the construction project, the quantity of the material remained and the pre-made component production plan. So that the purchase of the materials will not affect the construction period, and also it can reasonably reduce the construction cost of the building when the prices of the materials change with the market; at the same time, the user can also acquire the latest cost profit and loss of the construction project by checking a real-time cost profit and loss of the construction project acquired by calculating the procurement plan, the bid price and the cost profit and loss of the purchased materials, that is, users can acquire the cost profit and loss of the construction project in different periods in real time, it solves the technical problem that the construction cost of the building cannot be accurately predicted because the prices of the materials for the production components change with the market.

Optionally, acquiring the price information of the materials of the components at different purchase periods includes: acquiring historical purchase time of the materials of the components pre-stored on the prefabricated building construction platform and historical price information corresponding to the historical purchase time.

For example, before acquiring the historical purchase time of the materials of the components pre-stored in the prefabricated building construction platform and the historical price information corresponding to the historical purchase time, pre-storing the historical purchase time of the materials of the components in each construction project included in the prefabricated building construction platform and the historical price information corresponding to the historical purchase time in a database associated with the components; and acquiring the historical purchase time of the materials of the components pre-stored in the prefabricated building construction platform and the historical price information corresponding to the historical purchase time from the database.

Among them, each construction project included in the prefabricated building construction platform can be a construction project under construction or a completed construction project.

In one embodiment of the present application, the historical purchase time of the materials of the components in each construction project included in the prefabricated building construction platform and the historical price information corresponding to the historical purchase time are pre-stored in the database associated with the components. Then the historical purchase time of the materials of the components pre-stored on the prefabricated building construction platform and the historical price information corresponding to the historical purchase time are acquired from the database, so that the acquired price information of the materials of the components in different purchase periods is relatively complete, meanwhile, and the price change trend corresponding to the material of each component acquired by statistics based on the price information is more accurate.

In one embodiment of the present application, the database may be a relational database MySQL.

The prefabricated building construction platform can be built around the design, production, and construction integration of the prefabricated building; the architecture, structure, mechanical and electrical, interior decoration integration; the needs of technology, management, industry integration (referred to as the three integration); system integrated BIM, Internet, Internet of things, prefabricated buildings and other technologies; and innovatively developed architecture +Internet platform.

Step 102: acquiring a current price of the material, a bid price of the material, a cost profit and loss of the material that has been purchased for a construction project, a quantity of the material remained and a pre-made component production plan, and generating a procurement plan of the material according to the price change trend, the current price of the material, and the bid price of the material, the cost profit and loss of the material that has been purchased for the construction project, the quantity of the material remained and the pre-made component production plan.

Among them, the current price of the above material refers to the market price at the time of purchasing.

The bid price of the above material is the bid price of the component of the construction project after conversion according to a material composition of the component.

The cost profit and loss of the material that has been purchased for the construction project refers to a product sum of the difference between the price of the material purchased for the construction project at the time of purchase and the bid price of the material and the purchase quantity. When the price of the material purchased for the construction project at the time of purchase is greater than the bid price of the material, the price difference is negative and is a loss. When the price of the material purchased in the construction project at the time of purchasing is less than the bid price of the above material, the price difference is positive and is a profit. When the price of the material purchased for the construction project at the time of purchase is equal to the bid price of the above material, the price difference is zero, which means that there is no loss and no profit.

The quantity of the material remained refers to the amount of material hoarded in historical procurement of the construction project.

The pre-made component production plan refers to the component production plan formulated in conjunction with the construction period at the beginning of the construction project, that is, the components demand for each construction stage formulated according to the construction needs.

The procurement plan of the material includes the procurement plan for one or more batches of materials, and the procurement plan for each batch of materials includes the procurement time and procurement quantity of the material.

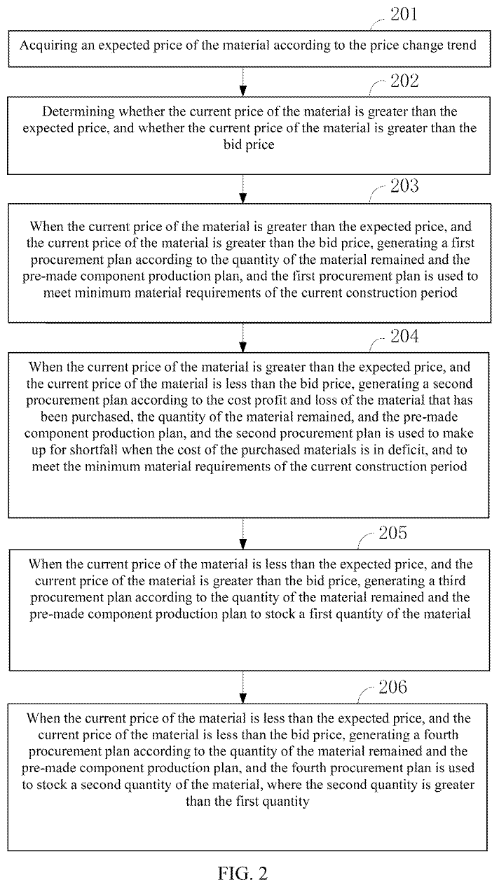

Specifically, as shown in FIG. 2, the step of generating a procurement plan of the material according to the price change trend, the current price of the material, the bid price of the material, the cost profit and loss of the material that has been purchased for the construction project, the quantity of the material remained and the pre-made component production plan may include step 201 to step 206.

Step 201: acquiring an expected price of the material according to the price change trend.

Step 202: determining whether the current price of the material is greater than the expected price, and whether the current price of the material is greater than the bid price.

The expected price refers to the price acquired by forecasting for a period of time in the future. In an embodiment of the present application, by determining whether the current price of the material is greater than the expected price, the future upward and downward trend of the price of the material can be acquired. When the current price is greater than or equal to the expected price, it indicates that the current price of the material is too expensive and not suitable for mass purchase. When the current price of the material is lower than the expected price, it indicates that the current price of the material is cheaper and it can be stocked in an appropriate amount.

The determination of whether the current price of the material is greater than the bid price is to calculate the profit and loss corresponding to material currently purchased. When the current price of the material is greater than the bid price, it indicates that this material purchase is a loss-making purchase. When the current price of the material is less than the bid price, it indicates that this material purchase is a profit purchase. Therefore, it is necessary to determine whether the current price of the material is greater than the expected price, and whether the current price of the material is greater than the bid price.

Optionally, acquiring the expected price of the material according to the price change trend includes: acquiring a price range of the material in a preset time period in the future according to the price change trend, and taking an average price of the price range as the expected price of the material.

For example, when the price change trend of the material is as shown in FIG. 3, if the current time is t1, the price range in the future preset time period [t1, t2] is [p1, p2], the expected price of the material is an average price (p1+p2)/2 in the above price range [p1, p2].

It should be noted that the above preset time period can be preset according to practical experience, or can be set according to the duration of each construction period. For example, it is set according to the expected time from the next material purchase.

Step 203: If the current price of the material is greater than the expected price, and the current price of the material is greater than the bid price, generating a first procurement plan according to the quantity of material remained and the pre-made component production plan; the first procurement plan is used to meet minimum material requirements of the current construction period.

In an embodiment of the present application, when the current price of the material is greater than or equal to the expected price, it indicates that the current price of the material is too expensive and may fall in the future, meanwhile, when the current price of the material is greater than the bid price, it indicates that the material purchase is a loss-making purchase, therefore, it is necessary to determine the first procurement plan based on the quantity of the material remained and the pre-made component production plan, and the first procurement plan is used to meet the minimum material requirements of the current construction period.

For example, when the quantity of the material remained can meet the material demand of the current construction period, the purchase quantity of the first procurement plan is zero.

Optionally, generating a procurement plan of the material according to the price change trend, the current price of the material, the bid price, the cost profit and loss of the material that has been purchased for the construction project, the quantity of the material remained, and the pre-made component production plan includes: generating a procurement plan for one or more batches of materials according to the price change trend, the current price of the material, the bid price, the cost profit and loss of the material that has been purchased for the construction project, the quantity of material remained and the pre-made component production plan, and the procurement plan for each batch includes a purchase time and a purchase quantity of the material.

For example, the first procurement plan specifically refers to the purchase time and purchase quantity of the material of each batch calculated according to the quantity of the material remained and the pre-made component production plan. For another example, the purchase quantity is an amount of materials purchased for one day, one week, or one month for each batch, and the purchase time of the materials of the first batch can be determined after calculating the time when the quantity of the material remained can be maintained according to the pre-made component production plan.

Specifically, the procurement plan for one or more batches of materials is generated, and the procurement plan for each batch of materials includes the purchase time and purchase quantity of the material. The materials can be purchased in batches according to the amount of the construction period; for example, to purchase the materials quantitatively every day according to the amount of the construction period, or purchase the materials quantitatively every week; or purchase all the materials for the construction project at one time.

Step 204: If the current price of the material is greater than the expected price, and the current price of the material is less than the bid price, generating a second procurement plan according to the cost profit and loss of the material that has been purchased, the quantity of the material remained, and the pre-made component production plan, the second procurement plan is used to make up for shortfall when the cost of the purchased material is in deficit, and to meet the minimum material requirements of the current construction period.

In an embodiment of the present application, when the current price of the material is greater than the expected price, it indicates that the current price of the material is too expensive and is not suitable for mass purchase. However, since the current price of the material is less than the bid price, it indicates that this material purchase is a profit purchase. Therefore, when there is a shortfall in the cost of the purchased material, the shortfall can be made up to meet the minimum material requirements of the current construction period, thereby reducing the risk of loss in material purchases.

Step 205: If the current price of the material is less than the expected price, and the current price of the material is greater than the bid price, generating a third procurement plan according to the quantity of the material remained and the pre-made component production plan to stock a first quantity of the material.

In an embodiment of the present application, when the current price of the material is less than the expected price, it indicates that the current price of the material is relatively cheap, and it can be stocked in an appropriate amount. However, since the current price of the material is greater than the bid price, it indicates that the material purchase is a loss-making purchase. In order to avoid further losses caused by subsequent material price increases, materials need to be hoarded. However, in order to control that the current price of the material is greater than the bid price and thus the loss of the material purchase can be cushioned to some extent. At this time, it is still not suitable to hoard excessive materials at one time. Therefore, the method for cost early warning of the prefabricated building combines the quantity of the material remained and the pre-made component production plan to automatically generate the third procurement plan, and stock the first quantity of the material.

It should be noted that the first quantity of material may refer to the quantity of materials that need to be used in recent construction periods, excluding the construction period for which the quantity of the material remained can be maintained.

Step 206: If the current price of the material is less than the expected price, and the current price of the material is less than the bid price, generating a fourth procurement plan according to the quantity of the material remained and the pre-made component production plan, and the fourth procurement plan is used to stock a second quantity of material, where the second quantity is greater than the first quantity.

In an embodiment of the present application, when the current price of the material is less than the expected price, it indicates that the current price of the material is relatively cheap and it can be stocked in an appropriate amount; at the same time, when the current price of the material is less than the bid price, it indicates that the material purchase is a profit purchase, therefore, the quantity of materials needed in the entire production process of the components can be acquired according to the quantity of the material remained and the pre-made component production plan, and the purchase can be carried out according to a preset ratio, for example, the entire amount of the materials in the construction project can be purchased at one time.

Step 103: Calculating a real-time cost profit and loss of the construction project according to the procurement plan, the bid price and the cost profit and loss of the purchased material.

Among them, the calculation of the real-time cost profit and loss of the construction project is the real-time cost profit and loss calculated according to market changes. The user can grasp the cost of the construction project in real time and the cost to be incurred in the future by comparing the real-time cost profit and loss with the pre-made cost plan, thereby realizing the cost early warning of the construction projects, and adjusting the procurement plan artificially.

In other words, the above procurement plan can be used as a reference for users. After calculating the real-time cost profit and loss of the construction project based on the procurement plan, the bid price and the cost profit and loss of the purchased material, users can make artificial adjustments to the above procurement plan under a guide of the real-time cost profit and loss to acquire the optimal procurement plan.

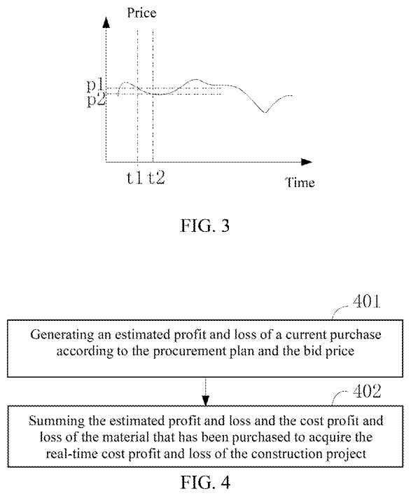

Specifically, as shown in FIG. 4, the calculation of the real-time cost profit and loss of the construction project based on the procurement plan, the bid price and the cost profit and loss of the purchased material includes: step 401 to step 402.

Step 401: Generating an estimated profit and loss of a current purchase according to the procurement plan and the bid price.

Since the procurement plan is a procurement plan generated before the execution of the purchase, thus the purchase cost generated according to the procurement plan is an estimated profit and loss generated based on the current price of the material and the bid price, and the estimated profit and loss is closer to the actual profit and loss.

Step 402: Summing the estimated profit and loss and the cost profit and loss of the material that has been purchased to acquire the real-time cost profit and loss of the construction project.

The real-time cost profit and loss refers to the latest cost profit and loss of construction project, which solves the technical problem that the construction cost of the building cannot be accurately predicted because the prices of materials for production components change with the market.

It should be understood that the size of the sequence number of each step in the embodiment does not mean the order of execution. The execution sequence of each process should be determined by its function and internal logic, and should not constitute any limitation on the implementation process of the embodiments of the present application.

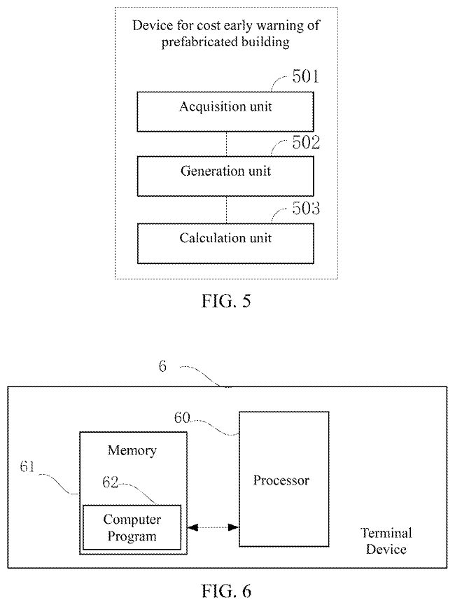

Refer to FIG. 5, which is a schematic diagram of a device for cost early warning of a construction project provided by an embodiment of the present application. For ease of description, only parts related to the embodiment of the present application are shown; including: an acquisition unit 501, a generation unit 502, and a calculation unit 503.

The acquisition unit 501 is configured to acquire price information of materials of components in different purchase periods, and perform statistics on the price information to acquire the price change trend corresponding to the material of each component.

The generation unit 502 is configured to acquire a current price of the material, a bid price of the material, a cost profit and loss of the material that has been purchased for the construction project, a quantity of material remained, and a pre-made component production plan; and to generate a procurement plan of the material according to the price change trend, the current price of the material, the bid price of the material, the cost profit and loss of the material that has been purchased for the construction project, the quantity of the material remained and the pre-made component production plan.

The calculation unit 503 is configured to calculate a real-time cost profit and loss of the construction project according to the procurement plan, the bid price and the cost profit and loss of the material that has been purchased.

Optionally, the acquisition unit 501 is specifically configured to acquire a historical purchase time of the material of the component pre-stored on the prefabricated building construction platform and historical price information corresponding to the historical purchase time.

Optionally, the device for cost early warning may also include a storage unit, which is specifically configured to pre-store the historical purchase time of the material of each building project contained in the prefabricated building construction platform and the historical price information corresponding to the historical purchase time into a database associated with the components. Correspondingly, the acquisition unit 501 is also specifically configured to acquire the historical purchase time of the material of the component pre-stored in the prefabricated building construction platform and the historical price information corresponding to the historical purchase time from the database.

Optionally, the generation unit is specifically used to acquire a current price level of the material according to the price change trend and the current price of the material; acquire a procurement method corresponding to the current price level of the material; and generate a procurement plan of the material according to the procurement method and the pre-made component production plan.

Optionally, the generation unit is also specifically used to acquire an expected price of the material according to the price change trend; determine whether the current price of the material is greater than the expected price, and determine whether the current price of the material is greater than the bid price. If the current price of the material is greater than the expected price, and the current price of the material is greater than the bid price, a first procurement plan is generated based on the quantity of the material remained and the pre-made component production plan. The first procurement plan is used to meet minimum material requirements of the current construction period. If the current price of the material is greater than the expected price, and the current price of the material is less than the bid price, a second procurement plan is generated based on the cost profit and loss of the purchased material, the quantity of material remained and the pre-made component production plan. The second procurement plan is used to make up for shortfall in the cost of the purchased materials, and meet the minimum material requirements of the current construction period. If the current price of the material is less than the expected price, and the current price of the material is greater than the bid price, a third procurement plan is generated based on the quantity of the material remained and the pre-made component production plan. The third procurement plan is used to stock a first quantity of material. If the current price of the material is less than the expected price, and the current price of the material is less than the bid price, a fourth procurement plan is generated based on the quantity of the material remained and the pre-made component production plan. The fourth procurement plan is used to stock a second quantity of material, where the second quantity is greater than the first quantity.

Optionally, the generation unit is also specifically used to generate a procurement plan for one or more batches of materials according to the price change trend, the current price of the material, the bid price, the cost profit and loss of the material that has been purchased for the construction project, the quantity of the material remained, and the pre-made component production plan, and the procurement plan for each batch of materials includes a purchase time and a purchase quantity of the material.

Optionally, the calculation unit is also specifically used to generate the estimated profit and loss of the current purchase according to the procurement plan and the bid price; sum the estimated profit and loss and the cost profit and loss of the purchased materials to acquire a real-time cost profit and loss of the construction project.

FIG. 6 is a schematic diagram of a terminal device provided by an embodiment of the present application. As shown in FIG. 6, the terminal device 6 of this embodiment includes: a processor 60, a memory 61, and a computer program 62 that is stored in the memory 61 and can run on the processor 60. When the processor 60 executes the computer program 62, the steps in the embodiment of the method for cost early warning OF each prefabricated building are implemented, such as steps 101 to 103 shown in FIG. 1. Alternatively, when the processor 60 executes the computer program 62, the functions of the modules/units in the device embodiments, such as the functions of the modules 501 to 503 shown in FIG. 5, are realized.

Exemplarily, the computer program 62 may be divided into one or more modules/units, and the one or more modules/units are stored in the memory 61 and executed by the processor 60 to complete the present application. The one or more modules/units may be a series of computer program instruction segments capable of completing specific functions, and the instruction segments are used to describe the execution process of the computer program 62 in the terminal device 6.

The terminal device 6 may be a computing device such as a desktop computer, a notebook, a palmtop computer, a cloud server, or a server. The terminal device may include, but is not limited to, a processor 60 and a memory 61. Those skilled in the art can understand that FIG. 6 is only an example of the terminal device 6 and does not constitute a limitation on the terminal device 6. It may include more or less components than shown in the figure, or a combination of certain components, or different components. For example, the terminal device may also include input and output devices, network access devices, buses, and so on.

The so-called processor 60 may be a central processing unit (CPU), other general-purpose processors, digital signal processor (DSP), application specific integrated circuit (ASIC), field-programmable gate array (FPGA) or other programmable logic devices, discrete gates or transistor logic devices, discrete hardware components, etc. The general-purpose processor may be a microprocessor or the processor may also be any conventional processor or the like.

The memory 61 may be an internal storage unit of the terminal device 6, such as a hard disk or a memory of the terminal device 6. The memory 61 may also be an external storage device of the terminal device 6, such as a plug-in hard disk, a smart memory card (SMC), a secure digital (SD) card, and a flash Card etc. equipped on the terminal device 6. Further, the memory 61 may also include both an internal storage unit of the terminal device 6 and an external storage device. The memory 61 is used to store the computer program and other programs and data required by the terminal device. The memory 61 may also be used to temporarily store data that has been output or will be output.

Those skilled in the art can clearly understand that for the convenience and conciseness of the description, only the division of the functional units and modules is used as an example. In practical applications, the functions can be allocated to different functional units and modules as required to complete, that is, the internal structure of the device is divided into different functional units or modules to complete all or part of the functions described above. The functional units and modules in the embodiments can be integrated into one processing unit, or each unit can exist alone physically, or two or more units can be integrated into one unit. The integrated units can be realized in a hardware-based form and can also be realized in the form of software functional unit. In addition, the specific names of the functional units and modules are merely for the convenience of distinguishing each other, and are not used to limit the protection scope of the present application. For the specific working process of the units and modules in the system, reference may be made to the corresponding process in the method embodiment, which is not repeated here.

In these embodiments, the description of each embodiment has its own focus. For parts that are not detailed described or recorded in an embodiment, reference may be made to related descriptions of other embodiments.

A person of ordinary skill in the art may realize that the units and algorithm steps of the examples described in combination with the embodiments disclosed herein can be implemented by electronic hardware or a combination of computer software and electronic hardware. Whether these functions are executed by hardware or software depends on the specific application and design constraints of the technical solution. Professionals and technicians can use different methods for each specific application to implement the described functions, but such implementation should not be considered beyond the scope of the present application.

In the embodiments provided in the present application, it should be understood that the disclosed apparatus/terminal device and method may be implemented in other ways. For example, the device/terminal device embodiments described above are merely illustrative. For example, the division of the modules or units is only a logical function division, and there may be other divisions in actual implementations, such as multiple units or components can be combined or integrated into another system, or some features can be ignored or not implemented. In addition, the displayed or discussed mutual coupling or direct coupling or communication connection may be indirect coupling or communication connection through some interfaces, devices or units, and may be in electrical, mechanical or other forms.

The units described above as separate components may or may not be physically separated, and the components displayed as units may or may not be physical units, that is, they may be located in one place, or they may be distributed on multiple network units. Some or all of the units may be selected according to actual needs to achieve the objectives of solutions of the embodiments.

In addition, the functional units in the various embodiments of the present application may be integrated into one processing unit, or each unit may exist alone physically, or two or more units may be integrated into one unit. The integrated unit can be realized in the form of hardware or software functional unit.

If the above integrated modules/units are implemented in the form of software functional units and sold or used as independent products, they can be stored in a computer readable storage medium. Based on this understanding, the present application implements all or part of the processes in the method embodiments, and can also be completed by instructing relevant hardware through a computer program. The computer program can be stored in a computer-readable storage medium. When executed by the processor, the steps of the method embodiments can be implemented. The computer program includes computer program code, and the computer program code may be in the form of source code, object code, executable file, or some intermediate forms. The computer-readable medium may include: any entity or device capable of carrying the computer program code, recording medium, U disk, mobile hard disk, magnetic disk, optical disk, computer memory, read-only memory (ROM), random access memory (RAM), electric carrier signal, telecommunications signal, software distribution medium, etc. It should be noted that the content contained in the computer-readable media can be appropriately added or deleted in accordance with the requirements of the legislation and patent practice in the jurisdiction. For example, in some jurisdictions, according to the legislation and patent practice, the computer-readable media does not include electrical carrier signals and telecommunication signals.

The above embodiments disclosed herein are merely used to illustrate the technical solutions of the present application, but not aimed to limit the present application. Although the present application is described in detail with reference to the embodiments, it should be understood for persons skilled in the art that modifications, or equivalent replacements of some of the technical features can be implemented under the spirit of the present application, and these modifications or replacements do not deviate the essence of the corresponding technical solutions from the spirit and scope of the technical solutions of the embodiments of the present application, and should be included by the protection scope of the present application.

1. A method for cost early warning of a prefabricated building, comprising:
acquiring price information of materials of components in different purchase periods, and performing statistics on the price information to acquire a price change trend corresponding to the material of each component;
acquiring a current price of the material of the component, a bid price of the material, a cost profit and loss of the material that has been purchased for a construction project, a quantity of the material remained and a pre-made component production plan, and generating a procurement plan of the material according to the price change trend, the current price of the material, and the bid price of the material, the cost profit and loss of the material that has been purchased for the construction project, the quantity of the material remained and the pre-made component production plan;
calculating a real-time cost profit and loss of the construction project according to the procurement plan, the bid price, and the cost profit and loss of the material that has been purchased.

2. The method for cost early warning according to claim 1, wherein the acquiring the price information of the materials of the components in different purchase periods comprises:
acquiring historical purchase time of the materials of the components pre-stored on a prefabricated building construction platform and historical price information corresponding to the historical purchase time.

3. The method for cost early warning according to claim 2, wherein before acquiring the historical purchase time of the materials of the components pre-stored on the prefabricated building construction platform and the historical price information corresponding to the historical purchase time, comprising:
pre-storing the historical purchase time of the materials of the components in each construction project contained in the prefabricated building construction platform and the historical price information corresponding to the historical purchase time in a database associated with the components;
correspondingly, the acquiring the historical purchase time of the materials of the components pre-stored on the prefabricated building construction platform and the historical price information corresponding to the historical purchase time comprises:
acquiring the historical purchase time of the materials of the components pre-stored on the prefabricated building construction platform and the historical price information corresponding to the historical purchase time from the database.

4. The method for cost early warning according to claim 1, wherein the generating the procurement plan of the material according to the price change trend, the current price of the material, and the bid price of the material, the cost profit and loss of the material that has been purchased for the construction project, the quantity of the material remained and the pre-made component production plan comprises;
acquiring an expected price of the material according to the price change trend;
determining whether the current price of the material is greater than the expected price, and determining whether the current price of the material is greater than the bid price;
when the current price of the material is greater than the expected price, and the current price of the material is greater than the bid price, generating a first procurement plan according to the quantity of the material remained and the pre-made component production plan, and the first procurement plan is used to meet minimum material requirements of the current construction period;
when the current price of the material is greater than the expected price, and the current price of the material is less than the bid price, generating a second procurement plan according to the cost profit and loss of the material that has been purchased, the quantity of the material remained, and the pre-made component production plan, and the second procurement plan is used to make up for shortfall when the cost of the purchased materials is in deficit, and to meet the minimum material requirements of the current construction period;
when the current price of the material is less than the expected price, and the current price of the material is greater than the bid price, generating a third procurement plan according to the quantity of the material remained and the pre-made component production plan, and the third procurement plan is used to stock a first quantity of the material;
when the current price of the material is less than the expected price, and the current price of the material is less than the bid price, generating a fourth procurement plan according to the quantity of the material remained and the pre-made component production plan, and the fourth procurement plan is used to stock a second quantity of the material, wherein the second quantity is greater than the first quantity.

5. The method for cost early warning according to claim 4, wherein the acquiring the expected price of the material according to the price change trend comprises:
acquiring a price range of the material within a preset time period in the future according to the price change trend, and take an average price of the price range as the expected price of the material.

6. The method for cost early warning according to claim 4, wherein the generating the material procurement plan according to the price change trend, the current price of the material, the bid price, the cost profit and loss of the material that has been purchased for the construction project, and the quantity of the material remained and the pre-made component production plan comprises:
generating a procurement plan for one or more batches of materials according to the price change trend, the current price of the material, the bid price, the cost profit and loss of the material that has been purchased for the construction project, the quantity of the material remained and the pre-made component production plan, and the procurement plan for each batch of materials comprises a purchase time and a purchase quantity of the material.

7. The method for cost early warning of claim 1, wherein the calculating the real-time cost profit and loss of the construction project according to the procurement plan, the bid price, and the cost profit and loss of the material that has been purchased comprises:
generating an estimated profit and loss of a current purchase according to the procurement plan and the bid price;
summing the estimated profit and loss and the cost profit and loss of the material that has been purchased to acquire the real-time cost profit and loss of the construction project.

8. A device for cost early warning of a prefabricated building, comprising:
an acquisition unit configured to acquire price information of the materials of the components at different purchase periods, and to perform statistics on the price information to acquire a price change trend corresponding to the material of each component;
a generation unit configured to acquire a current price of the material, a bid price of the material, a cost profit and loss of the material that has been purchased for a construction project, a quantity of the material remained and a pre-made component production plan, and to generate a procurement plan of the material according to the price change trend, the current price of the material, the bid price of the material, the cost profit and loss of the material that has been purchased for the construction project, the quantity of the material remained and the pre-made component production plan;
a calculation unit configured to calculate a real-time cost profit and loss of the construction project according to the procurement plan, the bid price and the cost profit and loss of the material that has been purchased.

9. A terminal device, comprising a memory, a processor, and a computer program stored in the memory and running on the processor, wherein the computer program implements the steps of the method according to claim 1 when the computer program is executed by a processor.

10. A computer-readable storage medium storing a computer program, wherein the computer program implements the steps of the method according to claim 1 when the computer program is executed by a processor.
